(19) United States
(12) Patent Application Publication
(10) Pub. No.: US 2026/0261120 A1
(43) Pub. Date: Sep. 3, 2026

(54) SWITCHING UNIT AND BACKUP SYSTEM FOR A HOUSEHOLD NETWORK

(71) Applicant: SMA Solar Technology AG, Niestetal (DE)

(72) Inventor: Sven Bremicker, Alheim-Baumbach (DE)

(21) Appl. No.: 19/657,063

(22) Filed: Apr. 24, 2026

Related U.S. Application Data
(63) Continuation of application No. PCT/EP2024/078626, filed on Oct. 11, 2024.

(30) Foreign Application Priority Data
Nov. 1, 2023 (DE) 10 2023 130 211.6
Jun. 21, 2024 (DE) 20 2024 103 393.0

(51) Int. Cl. H02J 3/001; H02J 3/388; H02J 9/06

(52) U.S. Cl. CPC H02J 3/001; H02J 3/388; H02J 9/06

(57) ABSTRACT

The disclosure describes a switching circuit for changing between network operation and island operation of a three-phase household network, having a first and a second positively driven relay, each having a control coil and a number of normally open contacts and a number of normally closed contacts. The terminals of the control coil of the second relay are connected in parallel to terminals of the control coil of the first relay via a first normally open contact of the first relay. The switching circuit is provided for input-side connection to one of the phase terminals of a network terminal and for output-side connection to a phase terminal of a household terminal. In a quiescent state, the second relay connects two of the phase terminals between the network terminal and the household terminal and, in a controlled state, connects the phase terminals of the household terminal to one another.

### REFERENCE TO RELATED APPLICATIONS

This application is a Continuation of International Application number PCT/EP2024/078626, filed on October 11, 2024, which claims the benefit of German Application number 202024103 393.0, filed on June 21, 2024 and also claims the benefit of German Application number 102023130 211.6, filed on November 1, 2023. The contents of the above-referenced Patent Applications are hereby incorporated by reference in their entirety.

### FIELD

The disclosure relates to a switching circuit between network operation and island operation of a household network, and to a backup system for a household network with such a switching circuit.

### BACKGROUND

The constant availability of electrical energy to supply a household has become a natural part of daily life. It is all the more disruptive, or even dangerous, when such a supply is interrupted due to a failure of the network. For this reason, there are so-called backup systems which, in this case, ensure the supply of the household from an energy storage system, for example, a battery and/or a DC generator, for example, a solar generator. If the network fails, the household must first be disconnected from the network before an island network can be set up, for example, by means of a voltage source inverter. To ensure a full supply for all loads, it is known to use a single-phase inverter and to connect the different phases of the household network together.

For example, the patent DE 10 2011 000 394 A1 shows a backup system in which, if the network fails, a control unit uses a first relay to disconnect all phases of the network from a consumer device, uses a second relay to connect the phases of the consumer device together, and uses a grid forming device to generate an island network. In this case, the first relay must be designed as a quiescent current relay and its control coil must therefore be permanently energized during network operation in order to prevent the consumer device from reconnecting during island operation due to a fault that unintentionally interrupts the energization of the first relay. The energy consumption of such a quiescent current relay causes significant additional costs for a backup system, even if it is not needed or almost never needed.

Furthermore, document DE 10 2012 023 424 A1 discloses a control device for an energy distribution system in which separately controllable first and second electromechanical isolating switches are interlocked against simultaneous switching on, wherein in network operation the first isolating switch connects a household to the network and in island operation the second isolating switch connects an output of a voltage-regulating inverter to the household. The inverter continues to be isolated from the network via a third disconnect switch in island operation. The interlocking can be achieved through a mechanically interlocking coupling between the relays. In network operation, the first isolating switch is therefore controlled.

Accordingly, the disclosure is directed to a switching circuit or a backup system that enables a fail-safe switching between network operation and island operation of a household network and has low energy consumption during network operation.

According to the disclosure, a switching circuit for changing between network operation and island operation of a three-phase household network comprises a first force-guided relay and a second force-guided relay, each having a control coil and a number of normally open contacts and a number of normally closed contacts. Terminals of the control coil of one of the two relays are connected in parallel to terminals of the control coil of the other relay via a first normally open contact of the other relay. The switching circuit in this case has an input side with input terminals each provided for connection to one of the phase terminals of a network terminal, and an output side with output terminals each provided for connection to a phase terminal of a household terminal, wherein a first output terminal is connected via a first normally closed contact of the first relay to a first input terminal, and via a first connection path comprising a first normally open contact of the second relay to a second output terminal and via a first connection path comprising a second normally open contact of the second relay to a third output terminal. Furthermore, the second output terminal is connected to a second input terminal via a first normally closed contact, and the third output terminal is connected to a third input terminal via a second normally closed contact.

By designing the first and second relays as force-guided relays in one embodiment, it can be ensured that an interconnection of the phases of the household network and a connection of the household network to the external network are mutually exclusive. This is because, in a force-guided relay, the switching contacts are mechanically rigidly connected to each other and can only move together, which, due to the design, even with welded contacts, makes it impossible for a normally closed contact and a normally open contact of the relay to be closed at the same time.

As a result, it is permissible not to have to energize the relays during network operation, i.e., to make the connection of the phases of the household network to the external network via normally closed contacts.

In a first embodiment of the disclosure, the terminals of the control coil of the second relay are connected in parallel to the terminals of the control coil of the first relay via a first normally open contact of the first relay. In this embodiment, the first relay switches first, and switching of the second relay requires correct switching of the first relay.

In a second embodiment of the disclosure, the terminals of the control coil of the first relay are connected in parallel to the terminals of the control coil of the second relay via a first normally open contact of the second relay. In this embodiment, the second relay switches first, and switching of the first relay requires correct switching of the second relay. Advantageously, in this case the first connection path is additionally routed via a first normally open contact of the first relay, and the second connection path is additionally routed via a third normally open contact of the first relay. Because both connection paths extend via normally open contacts of both relays, current can only flow through the connection paths after both relays have switched correctly. The output terminals are therefore only interconnected if both relays are switched correctly.

In both embodiments, it is advantageous to select relays in which the switching time between the termination of actuation of the relay and the first opening of a normally open contact of the relay is greater than the time interval between two successive zero crossings of the connected network, greater than 10 ms in the case of a 50 Hz network. The switching time is, in one embodiment, between twice and ten times this time interval. This ensures that when switching back from island operation to network operation, sufficient time elapses to allow the voltage of the household network to drop below a desired residual voltage value before connecting to the network, thus avoiding a load peak when reconnecting the household network to the connected network.

In another aspect of the disclosure, a backup system comprises the switching circuit as described above and a network terminal with phase terminals, each of which is connected to one of the input terminals of the switching circuit, wherein the network terminal provides a network monitoring signal that indicates the availability of a connected network. Furthermore, the backup system comprises a household terminal with phase terminals, each of which is connected to one of the output terminals of the switching circuit. A single-phase inverter with a controller is connected by means of its AC output via an isolating relay to the first output terminal of the switching circuit. The controller is in this case configured to receive the network monitoring signal and is connected to terminals of the control coil of the first relay and is configured to actuate the control coil when the network monitoring signal indicates a failure of the network.

In one embodiment, the controller is connected to a second normally open contact of the first relay in order to monitor the switching state of the first relay. This ensures that the inverter is only activated if the first relay switches successfully. A failure of the first relay is thus detected and a malfunction of the backup system is avoided. It should also be noted that if the first relay fails, the second relay will not switch at all, since its control coil is connected to the control coil of the first relay via a normally open contact – which does not close if the first relay fails.

In another embodiment of the disclosure, the controller is configured to actuate the control coil of the first relay with a first time delay after the network monitoring signal has indicated a failure of the network, and to terminate the actuation of the control coil of the first relay with a second time delay after the network monitoring signal has indicated a return of the network. This means that a brief network failure, for example, lasting one or a few seconds, will not lead to an unwanted activation of the backup system, and a brief return of the network did not lead to an unwanted deactivation.

In one embodiment, the controller is further configured to only cause the isolating relay to close, i.e., the generation of an island network in the household by the inverter, after a third time delay following the actuation of the control coil of the first relay after the network has been disconnected. This supports controlled generation of an island network in the household, as the third time delay allows for the suppression of remaining voltages in the household network.

When the network returns, the controller is advantageously configured to first open the isolating relay before terminating the actuation of the control coil of the first relay, i.e. before reconnecting the phases of the household network to the phases of the external network, thereby terminating the generation of the island network. The successful disconnection of the inverter from the household network can of course also be monitored by the inverter and made a prerequisite for reconnecting the phases of the household network to the phases of the external network.

### BRIEF DESCRIPTION OF THE FIGURES

The disclosure is illustrated below with reference to the figures, in which:

FIG. 1 shows a first embodiment according to the disclosure of a switching circuit within a backup system for a household network,

FIG. 2 shows a further embodiment according to the disclosure of a switching circuit within a backup system for a household network, and

FIG. 3 shows a flowchart for a method according to the disclosure for changing between network operation and island operation of a household network.

### DETAILED DESCRIPTION

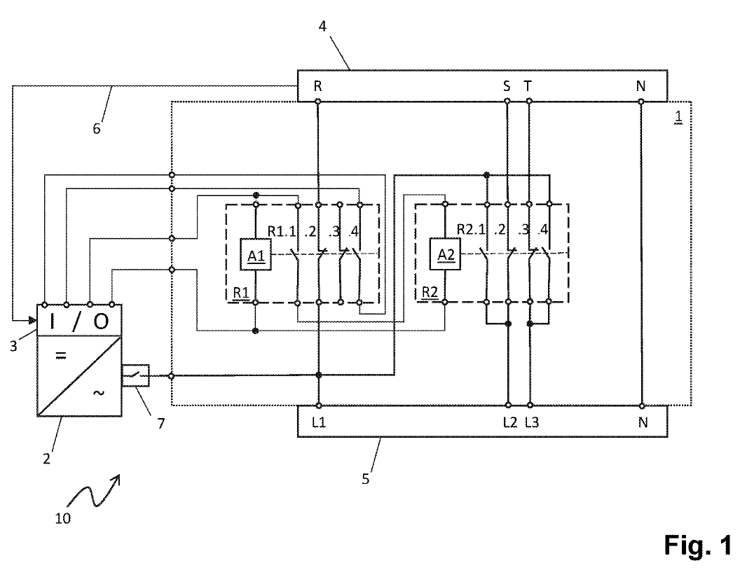

FIG. 1 shows a first embodiment according to the disclosure of a backup system 10 with a switching circuit 1 which connects input terminals R, S, T provided for connection to phase terminals of a three-phase power supply network with output terminals L1, L2, L3 provided for connection to phase terminals of a household network. The phase terminals are provided in a network terminal 4. The network terminal 4 also contains a network monitoring circuit that indicates the state of the power supply network by means of a network monitoring signal 6. This function can be fulfilled, for example, by an energy meter, but can also be implemented by a separate monitoring circuit. The consumers of the household are in turn distributed via a household terminal 5 to the individual phase terminals of the household network.

In network operation, the input terminals R, S, T of the three-phase power supply network are each electrically connected to one of the output terminals L1, L2, L3 via a first relay R1 and a second relay R2 via normally closed contacts R1.2, R2.2, R1.3, R2.3, so that in network operation no control of the control coils A1, A2 of the two relays R1, R2 is required and thus no corresponding power loss occurs.

For actuation of the first relay R1, the terminals of the first control coil A1 are connected to a signal output of a controller 3 of a voltage-regulating inverter 2. The control coil A2 of the second relay R2 is connected in parallel to the control coil A1 of the first relay R1 via a first normally open contact R1.1 of the first relay R1. In this way, the switching state of the first relay R1 and of the second relay R2 can be jointly determined by the controller 3 of the inverter 2, wherein the second relay R2 is only controlled if the first relay R1 switches correctly.

The second relay R2 is wired in such a way that in the quiescent state it connects two of the input terminals S, T to assigned output terminals L2, L3 and in the activated state connects the assigned output terminals L2, L3 to the remaining output terminal L1. For this purpose, two normally closed contacts R2.2, R2.3 are connected on one side to one of the input terminals S, T and on the other side to the assigned output terminals L2, L3. Furthermore, the output terminals L2, L3 are each connected to the remaining output terminal L1 via a normally open contact R2.1, R2.4. By designing the second relay R2 as a force-guided relay in one embodiment, it is impossible for one of the normally closed contacts R2.2, R2.3 and simultaneously one of the normally open contacts R2.1, R2.4 to be closed.

The voltage-regulating inverter 2 is also connected to the output terminal L1 via an isolating relay 7. This allows the inverter 2, via its controller 3, to trigger actuation of the switching circuit 1 via the signal output of the controller 3 upon receiving a network monitoring signal 6 indicating a network failure, in order to isolate the household network from the power supply network and interconnect all phases of the household network to a common phase. Subsequently, the inverter 2 can form a single-phase island network, for example, initially with the isolating relay 7 open, and maintain this after the isolating relay 7 is closed to supply the consumers of the household network.

The first relay R1 has an optional normally open contact R1.4, which is connected to a signal input of the controller 3, and via which the controller 3 can verify the switching state of the first relay R1. In this way, the correct switching function of the first relay R1 can be monitored. This optional relay contact can also be designed as a normally closed contact and can also be arranged in the second relay R2 instead of the first relay R1.

In FIG. 1, in the first relay R1, an unused normally closed contact R1.3 is shown which is not absolutely necessary, but demonstrates the fact that the two relays R1, R2 can be identical in construction, which is often advantageous for cost reasons. Of course, different relay designs are also conceivable, including those with more or less unused contacts. It is also conceivable to route the neutral conductor N, which is permanently connected between the household network and the supply network in FIG. 1, via the normally closed contact R1.3 instead.

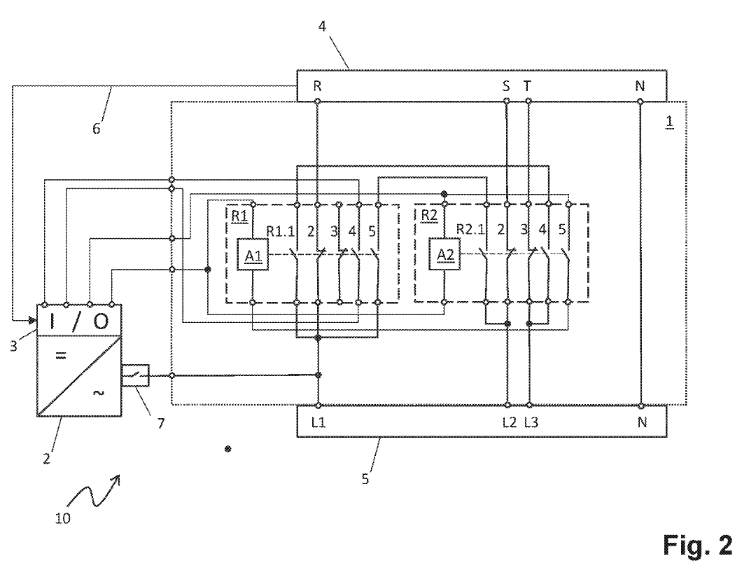

The switching circuit according to FIG. 2 represents a further embodiment according to the disclosure which, in the case of unfavorably short intervals between the switching points of the switching contacts of the force-guided relays, for example, when the time interval between the opening of a normally closed contact and the closing of a normally open contact is smaller than the time interval between two zero crossings of the network voltage, avoids short circuits between network phases that may occur briefly. In this embodiment, both the first relay R1 and the second relay R2 have an additional third normally open contact R1.5, R2.5, the use of which is explained below.

In this embodiment, the terminals of the second control coil A2 for controlling the second relay R2 are also connected to the signal output of the controller 3 of the voltage-regulating inverter 2. The control coil A1 of the first relay R1 is now connected in parallel to the control coil A2 of the second relay R2 via the third, additional normally open contact R2.5 of the second relay R2 compared to the first embodiment. In this way, the switching state of the first relay R1 and of the second relay R2 can be jointly determined by the controller 3 of the inverter 2, wherein the first relay R1 is controlled if and only if the second relay R2 has already switched correctly. This results in a delay between the switching times of the earlier switching second relay R2 and the switching times of the later switching first relay R1. In one embodiment force-guided relays are employed in which a delay between the control of the control coil and the resulting closing of the normally open contacts is ensured that is longer than the time between two successive zero voltage crossings of the supply network, 10 ms in the case of a 50 Hz network.

Furthermore, in this embodiment, the electrical connections between the output terminals L2 and L3 with the output terminal L1, to which the inverter 2 is connected, are now made from a series connection of two normally open contacts, which are arranged on different ones of the two relays R1, R2. Thus, the electrical connection path between the output terminals L2 and L1 now extends via the normally open contacts R1.5 and R2.1, and the electrical connection path between the output terminals L3 and L1 is routed via the normally open contacts R1.1 and R2.4. The choice of the delay described above between controlling the control coil and the resulting closing of the normally open contacts ensures that when the household network is isolated from the supply network, the output terminals L2 and L3 are the first to be isolated from the input terminals S and T, and that the normally open contacts R1.1 and R1.5 of the first relay R1 are still open at this time. This prevents any arcing that may occur between the normally closed contacts R2.2 and R2.3 of the second relay R2 from short-circuiting the input terminals S and T connected to the corresponding phases of the supply network, even when the normally open contacts R2.1 and R2.4 of the second relay R2 close.

The other electrical connections between the switching contacts of the two relays R1, R2 are implemented in the same way in both embodiments.

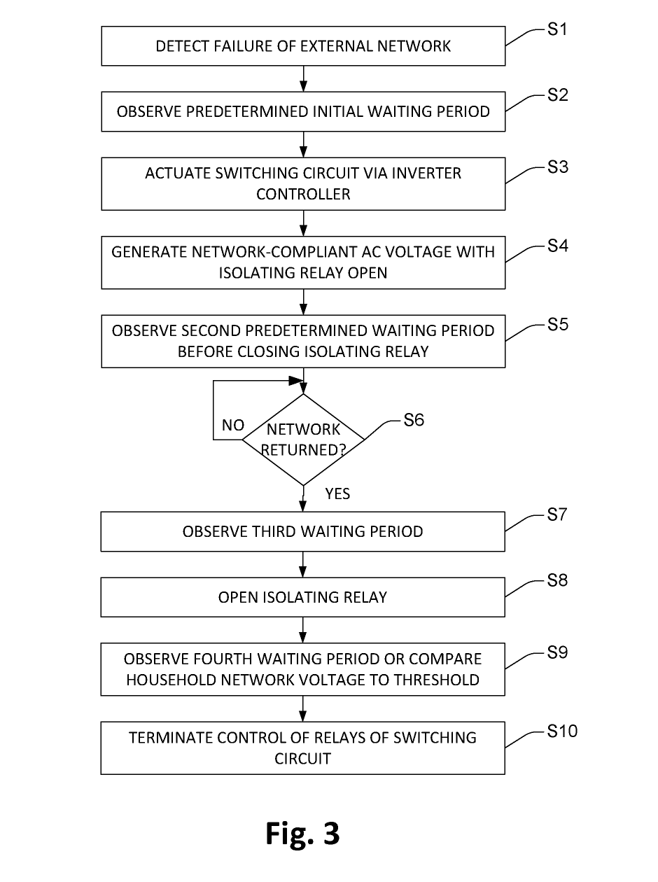

FIG. 3 shows a flowchart for one embodiment of a method for operating a household network. In its initial state, the household network is connected to the external network via the switching circuit. In this state, the first relay R1 and the second relay R2 are in the quiescent state, i.e., without current, so that the connection of the individual phases takes place via the closed normally closed contacts of the relays. In a first act S1, a failure of the external network is detected. This can be done, for example, by means of an electricity meter integrated into the network connection or by means of other known monitoring devices. The failure of the network is transmitted to the controller of the inverter via a network monitoring signal. Alternatively, the detection of the failure of the external network can also be carried out directly by the inverter, for example, by monitoring the network voltage and/or network frequency at a connection point of the inverter, thus eliminating the need to transmit a network monitoring signal.

In a second act S2, a predetermined initial waiting period is first observed before, in a third act S3, the switching circuit is actuated by the controller of the inverter, causing the relays of the switching circuit to change from the quiescent state to the activated state. This waiting period serves the purpose of not switching directly to an emergency power supply in the event of a short-term network failure, thus avoiding unnecessary switching operations of the switching circuit. Therefore, a waiting time between 10 seconds and several minutes can be selected here, for example, one, two or three minutes.

In a fourth act S4, the inverter first generates a network-compliant AC voltage with the isolating relay open, which can, in one embodiment, also be generated synchronously with the phase of the external network before the failure, and a second predetermined waiting period is observed before the isolating relay is closed in a fifth act S5, so that the inverter takes over the supply of the household network for as long as the network failure lasts. A waiting period in the range of a few seconds, for example, 5 or 10 seconds, is sufficient to allow any residual voltages on the phases of the household to dissipate and to ensure that devices are safely switched off.

Act S6 comprises waiting for the network to return, so that the method remains in the sixth act S6 until that time (NO at act S6 if the network has not yet returned) and the household network is maintained by the inverter.

If a returning network is detected by the network monitoring signal (YES at act S6), a third waiting period is initially observed in a seventh act S7 in case the network only returns briefly and then fails again immediately. In this case, it is better to supply the household network continuously via the inverter. Only after the third waiting period has elapsed is the isolating relay of the inverter opened in an eighth act S8, thereby ending the supply of power to the household network by the inverter. The third waiting period can be in the range of minutes, for example, 2 minutes, 5 minutes or 10 minutes. Subsequently, in a ninth act S9, a fourth waiting period is observed so that the consumers of the household network can enter a defined quiescent state from which they can be supplied again without failure. Instead of a predetermined fourth waiting period, the voltage of the household network can also be compared with a predetermined threshold, and the ninth act S9 is terminated if the voltage falls below the threshold.

In a final tenth act S10, the control of the relays of the switching circuit is terminated, so that they return to their quiescent state. This removes the interconnection of the phases of the household network before a new connection is made between the individual phase of the external network and the household network. From this moment on, consumers in the household network will again be supplied via the external network.

What is claimed is:

1. A switching circuit for changing between network operation and island operation of a three-phase household network, comprising:
a first force-guided relay and a second force-guided relay, each comprising a control coil and a number of normally open contacts and a number of normally closed contacts, wherein terminals of the control coil of one of the first force-guided relay and the second force-guided relay are connected in parallel to terminals of the control coil of the other of the first force-guided relay and the second force-guided relays via a first normally open contact of the other of the first force-guided relay and the second force-guided relay,
wherein the switching circuit comprises an input side with input terminals each provided for connection to one of a plurality of respective phase terminals of a network terminal and an output side with output terminals each provided for connection to a phase terminal of a household terminal,
wherein a first output terminal is connected via a first normally closed contact of the first force-guided relay to a first input terminal and via a first connection path comprising a first normally open contact of the second force-guided relay to a second output terminal and via a second connection path comprising a second normally open contact of the second force-guided relay to a third output terminal, and
wherein the second output terminal is connected to a second input terminal via a first normally closed contact and the third output terminal is connected to a third input terminal via a second normally closed contact.

2. The switching circuit according to claim 1, wherein the terminals of the control coil of the second force-guided relay are connected in parallel to the terminals of the control coil of the first force-guided relay via a first normally open contact of the first force-guided relay.

3. The switching circuit according to claim 1, wherein the terminals of the control coil of the first force-guided relay are connected in parallel to the terminals of the control coil of the second force-guided relay via a first normally open contact of the second force-guided relay.

4. The switching circuit according to claim 3, wherein the first connection path is additionally routed via a first normally open contact of the first force-guided relay and the second connection path is additionally routed via a third normally open contact of the first force-guided relay.

5. The switching circuit according to claim 1, wherein the first and second force-guided relays have switching times between a termination of an actuation of the first and second force-guided relays and a first opening of a normally open contact of the first and second force-guided relays which are greater than a time interval between two successive zero crossings of a voltage of a connected network.

6. A backup system, comprising:
a switching circuit, comprising:
a first force-guided relay and a second force-guided relay, each comprising a control coil and a number of normally open contacts and a number of normally closed contacts, wherein terminals of the control coil of one of the first force-guided relay and the second force-guided relay are connected in parallel to terminals of the control coil of the other of the first force-guided relay and the second force-guided relays via a first normally open contact of the other of the first force-guided relay and the second force-guided relay,
wherein the switching circuit comprises an input side with input terminals each provided for connection to one of the phase terminals of a network terminal and an output side with output terminals each provided for connection to a phase terminal of a household terminal,
wherein a first output terminal is connected via a first normally closed contact of the first force-guided relay to a first input terminal and via a first connection path comprising a first normally open contact of the second force-guided relay to a second output terminal and via a second connection path comprising a second normally open contact of the second force-guided relay to a third output terminal, and
wherein the second output terminal is connected to a second input terminal via a first normally closed contact and the third output terminal is connected to a third input terminal via a second normally closed contact;
a network terminal with phase terminals, each of which is connected to one of the input terminals of the switching circuit, wherein the network terminal provides a network monitoring signal that indicates an availability of a connected network,
a household terminal with phase terminals, each of which is connected to one of the output terminals of the switching circuit,
a single-phase inverter with a controller, wherein the single-phase inverter is connected by means of an AC output via an isolating relay to the first output terminal of the switching circuit, and
wherein the controller is configured to receive the network monitoring signal and is connected to terminals of the control coil of the other of the first force-guided relay and the second force-guided relay and is configured to actuate the control coil when the network monitoring signal indicates a failure of the connected network.

7. The backup system according to claim 6, wherein the controller is connected to a second normally open contact of the first force-guided relay to monitor a switching state of the first force-guided relay.

8. The backup system according to claim 6, wherein the controller is configured to:
control the control coil of the other of the first force-guided relay and the second force-guided relay with a first time delay after the network monitoring signal has indicated a failure of the network, and
terminate the control of the control coil of the other relay of the first force-guided relay and the second force-guided relay with a second time delay after the network monitoring signal has indicated a return of the network.

9. The backup system according to claim 8, wherein the controller is configured to cause an isolating relay associated with the single-phase inverter to close after a third time delay following an actuation of the control coil of the other relay of the first force-guided relay and the second force-guided relay after the network fails.

10. The backup system according to claim 8, wherein the controller is configured to first open the isolating relay upon return of the network before an actuation of the control coil of the other relay of the first force-guided relay and the second force-guided relay is terminated.
